(19) United States
(12) Patent Application Publication
(10) Pub. No.: US 2026/0102795 A1
(43) Pub. Date: Apr. 16, 2026

(54) CLEANING TOOL FOR SMALL SPACES

(71) Applicant: Malchiel-Melchior P. La' Viollette, San Diego, CA (US)

(72) Inventor: Malchiel-Melchior P. La' Viollette, San Diego, CA (US)

(21) Appl. No.: 19/353,897

(22) Filed: Oct. 9, 2025

Related U.S. Application Data
(60) Provisional application No. 63/706,016, filed on Oct. 10, 2024.

(51) Int. Cl. B08B 6/00; B08B 1/10; B08B 1/30; B60S 3/00

(52) U.S. Cl. CPC B08B 6/00; B08B 1/10; B08B 1/30; B60S 3/008

(57) ABSTRACT

Apparatuses and methods for cleaning small spaces are disclosed. A cleaning tool for small spaces comprises a body having a substantially rectangular portion, the rectangular portion defining a length, a width, and a thickness, wherein the body comprises a surface material and the length of the rectangular portion is longer than the width of the rectangular portion, and the width of the rectangular portion is longer than the thickness of the rectangular portion.

### RELATED APPLICATION(S)

This application claims the benefit of priority to U.S. Provisional Application No. 63/706,016, filed Oct. 10, 2024, which is hereby incorporated by reference in its entirety.

### TECHNICAL FIELD

Embodiments of the present disclosure are related to a tool for cleaning small spaces, such as the small spaces in a car.

### BACKGROUND OF THE DISCLOSURE

Extracting debris from beneath a car seat is routinely impeded by the inherent spatial constraints and structural geometry of the car's interior. The lack of a clear line-of-sight, full manual articulation, and unimpeded tool access ordinarily prevent effective debris retrieval. The small gap between the seat's lower frame and the floor pan, compounded by the presence of seat-adjustment tracks, electrical harnesses, and ancillary components such as air-bag sensors or heating elements, functions as a de facto barrier, restricting both the angle and extent to which a hand, vacuum attachment, or other implement may be introduced. Moreover, the car floor carpet's weave and the track assemblies create a myriad of crevices in which debris—ranging from granular dirt and food crumbs to metallic or plastic fragments—can lodge, resisting extraction despite repeated passes of suction or agitation. There is a need for a cleaning tool that may fit into crevices and small narrow spaces to remove debris from such spaces.

### SUMMARY

Here, an innovative tool to clean and remove debris from underneath a car seat is described.

In certain embodiments, described herein is a cleaning tool for small spaces comprises a body having a substantially rectangular portion, the rectangular portion defining a length, a width, and a thickness, wherein the body comprises a felt material and the length of the rectangular portion is longer than the width of the rectangular portion, and the width of the rectangular portion is longer than the thickness of the rectangular portion.

In some embodiments, the cleaning tool further comprises at least one tapered portion extending from the body, thereby increasing the length of the rectangular portion.

In some embodiments, the at least one tapered portion comprises a handle.

In some embodiments, the at least one tapered portion comprises a grip material with a different texture from surface material of the body.

In some embodiments, the cleaning tool further comprises at least one protrusion extending from the body, thereby increasing the width of the rectangular portion.

In some embodiments, the at least one protrusion comprises a handle.

In some embodiments, the at least one protrusion comprises a grip material with a different texture from the surface material of the body.

In some embodiments, the cleaning tool further comprises a first protrusion; and a second protrusion, wherein the second protrusion is larger than the first protrusion, wherein the first and the second protrusion extend from the body, thereby increasing the width of the rectangular portion.

In some embodiments, the rectangular portion comprises a core portion formed of a semi-rigid material; and a skin portion encasing the core portion.

In some embodiments, a surface of the skin portion comprises a material smoother than that of the core portion.

In some embodiments, a surface of the skin portion comprises a material that produces a static electric charge that captures debris.

In some embodiments, the felt material of the body comprises a washable material.

In some embodiments, the felt material of the body comprises a stiffened felt.

In some embodiments, the rectangular portion comprises a rubber or plastic material.

In some embodiments, the rectangular portion comprises a stiffened felt material or a stiff felt material.

In certain embodiments, described herein is a method of using a cleaning tool in a small space comprises inserting a cleaning tool into a small space, the cleaning tool comprising a body having a substantially rectangular portion, the rectangular portion defining a length, a width, and a thickness; pulling the cleaning tool through the small space, for example from a distal to a proximal position; and removing the cleaning tool from the small space; and optionally removing collected debris from the cleaning tool.

In some embodiments, the cleaning tool further comprises a handle by which a user can pull the cleaning tool.

In some embodiments, the rectangular portion of the cleaning tool defines a length, a width, and a thickness, the length of the rectangular portion is longer than the width of the rectangular portion, and the width of the rectangular portion is longer than the thickness of the rectangular portion.

In some embodiments, the cleaning tool comprises a felt material.

In some embodiments, the small space comprises a gap between a car seat and a floor material of a car.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1A is an illustration of the front and side views of a cleaning tool, in accordance with one or more embodiments of this disclosure.

FIG. 1B is an illustration of the front and side views of a cleaning tool with a handle, in accordance with one or more embodiments of this disclosure.

FIG. 2 is an illustration of a small space between the rail of an automobile seat and the floor of the automobile with debris, in accordance with one or more embodiments of this disclosure.

FIG. 3 is an illustration of a cleaning tool in use to remove debris from the small space between the rail of an automobile seat and the floor of the automobile, in accordance with one or more embodiments of this disclosure.

FIG. 4A is an illustration of a cleaning tool, in accordance with one or more embodiments of this disclosure.

FIG. 4B is an illustration of a cleaning tool with a handle, in accordance with one or more embodiments of this disclosure.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal. ” Moreover, the terms “a” and “an” herein do not denote a limitation of quantity, but rather denote the presence of one or more of the referenced items.

It will be understood that, although the terms “first,” “second,” etc., may be used herein to describe various elements, these elements should not be limited by these terms.

These terms are only used to distinguish one element from another element. For instance, a first element discussed below could be termed a second element without departing from the teachings of the disclosure. Similarly, the second element could also be termed the first element. In the specification and the claims, the singular forms are intended to include the plural forms as well, unless the context clearly indicates otherwise.

Also, the terms “under,” “below,” “above,” “upper,” and the like are used herein for explaining relationship between one or more components illustrated in the drawings. These terms may be relative terms describing the positions of components in the drawings, but the positions of components are not limited thereto.

It will be further understood that the terms “comprise,” “include,” “have,” etc., when used in this specification, specify the presence of stated features, integers, steps, operations, elements, components, and/or combinations of them but do not preclude the presence or addition of one or more other features, integers, steps, operations, elements, components, and/or combinations thereof.

In the specification and the claims, the phrase “at least one of” is intended to include the meaning of “at least one selected from the group of” for the purpose of its meaning and interpretation. For example, “at least one of A and B” may be understood to mean “A, B, or A and B.” The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art.

“About” or “approximately” as used herein is inclusive of the stated value and means within an acceptable range of deviation for the value as determined by one of ordinary skill in the art, considering the measurement in question and the error associated with measurement of the quantity (i.e., the limitations of the measurement system). For example, “about” may mean within one or more standard deviations, or within ±30%, 20%, 10%, 5% of the stated value.

It will be understood that when an element (or a region, a layer, a portion, or the like) is referred to as “being on,” “connected to,” or “coupled to” another element in the specification, it can be directly disposed on, connected or coupled to another element mentioned above, or intervening elements may be disposed therebetween.

The space underneath car seats remains a stubborn area for dirt, debris, small objects, and other items that may be hard to dislodge for a user. A small tool designed for cleaning this area is described herein, the tool having useful parameters and materials to collect items from underneath car seats and other small spaces.

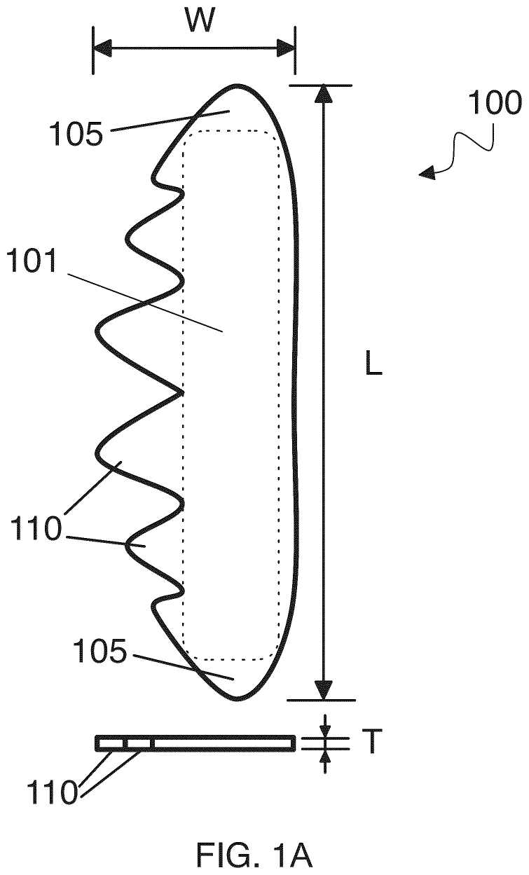

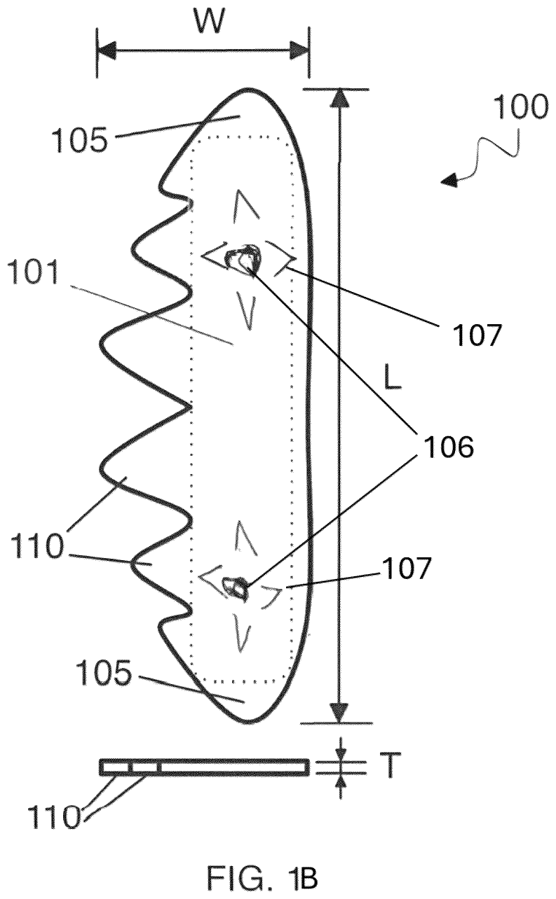

FIG. 1A is an illustration of the front and side views of a cleaning tool 100, in accordance with one or more embodiments of this disclosure. The cleaning tool 100 may fit into crevices and small narrow spaces. The cleaning tool 100 may comprise a rectangular portion 101 made from a semi-rigid material, where the sides of the rectangular portion 101 define a length L, width W, and thickness T, where the length L is longer than the width W, and the width W is longer than the thickness T.

An example of a small narrow space would be the gap between the rails supporting the front seat of an automobile and the floor of the automobile. The cleaning tool 100 may be pushed and pulled through the gap along the length L direction to remove debris in the gap.

The shape of the rectangular portion 101 is not limited to geometric rectangles and may include substantially rectangular shapes where the length L is longer than width W. For example, in some embodiments, the width of one side of the rectangular portion may be shorter than the width of the other side, forming a rhomboid. In other embodiments, the thickness may not be uniform across the rectangular portion, and the rectangular portion may have substantially a wedge shape in the side view. In such cases, the length L, width W, and thickness T of the rectangular portion will be defined by the largest measurement. Similarly, the sides of the rectangular portion are not limited to straight lines and may include irregular shapes such as curves, or wavy/jagged lines.

In certain embodiments, the semi-rigid material comprising the rectangular portion 101 may be any material that is rigid enough to be pushed through the narrow space or gap while flexible enough to bend or fold around the surrounding structures such as the metal rails. It is noted that the material retains its shape during use, so as to sufficiently gather debris without additional support necessary from the user.

An example of such a semi-rigid material may be a stiffened felt cloth. The stiffened felt cloth may be a single piece of felt, a felt cover for a rectangular portion of a different material, a felt cover over additional pieces of felt, or any other suitable felt. The felt may be stiffened by a chemical agent, a treatment, or reinforced by additional material to better collect debris during use. The embodiments include but are not limited to such cloths and may also include plastic, rubber materials, a malleable metal sheet within a cover, or any other material with the balance of rigidity and flexibility to move through narrow gaps and remove debris.

Furthermore, the semi-rigid material comprising the rectangular portion 101 may be a composite of two or more materials. In some embodiments, the rectangular portion 101 may comprise a semi-rigid core material that is encased in a smoother material comprising the skin. For example, the core material may comprise a rubber material encased in a fabric cover that may be easily pushed though narrow gaps.

In some embodiments, the skin may comprise a washable material that has a static charge that can catch debris. The washable material may be easily cleaned, for example, using water and soap or detergent.

In certain embodiments, the width W and length L may vary to fit into a variety of the narrow spaces the cleaning tool 100 may clean. The width W and length L may be in a range that is convenient for the user to push and pull by hand without using other tools. In other embodiments, the width W and length L may be small enough to be easily carried in a pocket or purse, or to fit into a glove compartment of a vehicle. In some embodiments, the semi-rigid material may be folded for easier carrying or storage without damage while sufficiently large to quickly clean larger gaps.

In certain embodiments, the thickness T of the rectangular portion 101 may be within a range of less than about 1 mm to about 2 mm. However, the embodiments are not limited to this range, and depending on the strength of the semi-rigid material the thickness T may be less than 0.1 mm. Depending on the gaps the cleaning tool is intended to clean, the thickness T may be greater than 3 mm.

In some embodiments, the cleaning tool 100 may include a tapered portion 105 that helps the user pull the cleaning tool 100 through a narrow gap. A tapered portion 105 may extend from one or both of the sides defining the width W of the rectangular portion 101. Thus, tapered portions 105 may increase the length L of the cleaning tool 100. As illustrated in FIG. 1, the embodiments may include a tapered portion 105 at both sides of the rectangular portion 101.

In some embodiments, the cleaning tool 100 may include a protrusion 110 that helps remove debris that may be attached within a gap. The protrusion 110 may extend from one of the sides defining the length L of the rectangular portion 101 of the cleaning tool 100. The protrusion 110 may increase the width W of the cleaning tool 100. Some embodiments may include multiple protrusions 110 of different sizes. For example, the cleaning tool may include a first protrusion and a second protrusion, where the second protrusion is larger than the first protrusion.

It is contemplated that the protrusion 110 may include a handle or may indicate where the user is to grip the tool, in some embodiments. An indication of where to grip may be shown on protrusion 110 by a color, change in texture of the material, or printed text on the tool to thereby illustrate to the user to grip this area.

In some embodiments, the handle on protrusion 110 may comprise a small body for the user to grip and thereby push or pull the tool. The handle may be one of the multiple protrusions 110 on the body of the cleaning tool 100. In some embodiments, the handle may be plastic, rubber, felt, or some other suitable fabric.

In some embodiments, the tapered portion 105 may include a handle or indicator for the user to grip. The handle may comprise a surface for the user to grip, or a protrusion attached at two points for the user's hand to hold. In some embodiments, more than one handle may be present on the cleaning tool 100 for the user to push or pull the cleaning tool 100 through the gap or small space for cleaning.

In some embodiments, the tool may comprise one or more dedicated grip spaces as indicated by a color, change in texture or material, or printed text on the tool to thereby illustrate to the user to grip this area. The dedicated grip spaces may be on one or both of the tapered portions 105 as shown in FIG. 1A.

FIG. 1B is an illustration of the front and side views of a cleaning tool 100 with a thumbprints 106 and corresponding cutouts 107, in accordance with one or more embodiments of this disclosure. The thumbprint 106 indicates an area on the tool where the user places his or her thumb while the user's fingers are placed in the cutouts 107 to hold the tool. The grip begins with one hand of the user, and the other hand will grip an opposite end of the tool 100 to pull the tool under and through a small space, such as under and through the end of a shifting seat bar in a car. The felt material of the tool 100 will attract and keep any debris during use, and the utilization of the tool 100 may begin with one hand gripping the tool 100 at thumbprints 106 and cutouts 107, and end with the other hand gripping either the same thumbprint 106 or a second thumbprint 106 and cutouts 107. In some embodiments, the user may apply the tool 100 with a single hand. In some embodiments, the user may apply the tool using both hands.

Thumbprints 106 may be colored indications of thumb placement. In some embodiments, the thumbprints 106 may be the same felt material as the rest of the tool 100. In some embodiments, the thumbprints 106 may comprise a different material.

Cutouts 107 may be slits cut into the material of the tool 100 for finger placement. In some embodiments, the user's fingers may pass through the body of the tool 100 for better grip. In some embodiments, the user's fingers do not pass through the body of the tool 100. While cutouts 107 are shown as triangular cutouts, it is contemplated that any shape cutout may be used. The cutouts 107 may be arranged circularly around the thumbprint 106.

In some embodiments, the thumbprints 106 and the cutouts 107 are present on both the front (shown) and back (not shown) sides of the tool 100. In some embodiments, the thumbprints 106 and cutouts 107 are only present on one side of the tool 100. In some embodiments, the thumbprints 106 and cutouts 107 comprise a handle. In some embodiments, only one thumbprint 106 and a corresponding set of cutouts 107 are present on the tool.

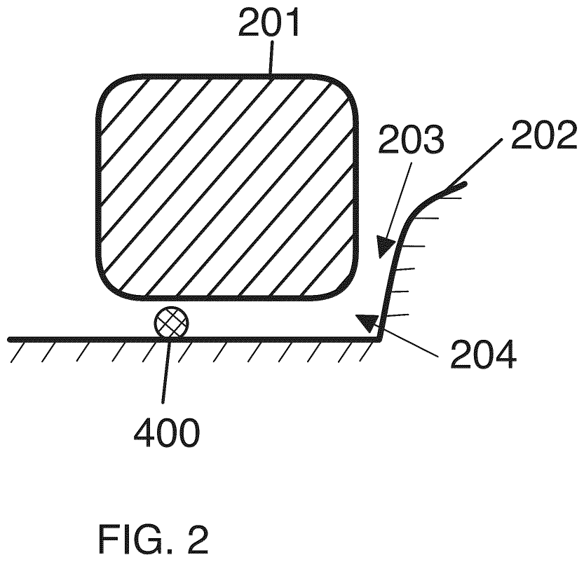

FIG. 2 is a side view of a narrow gap 203 between the rail 201 supporting an automobile front seat and the floor 202 of the automobile with debris 303 as an example of what the cleaning tool 100 in FIG. 1 may clean. The narrow gap 203 may have a bent portion 204 that makes the debris 400 difficult to reach and clean out. The bent portion 204 may mirror the topography of the automobile floor. The floor 202 may be covered in a carpet, plastic, rubber, or other suitable material, such that the material of the cleaning tool 100 is able to easily pick up debris 400 from the floor 202.

Debris 303 may include a wide range of materials found on the floors of automobiles. Debris may include, but is not limited to, glass, dirt, hair, small objects, materials tracked into the automobile on shoes, materials dropped by passengers, and/or other substances and materials.

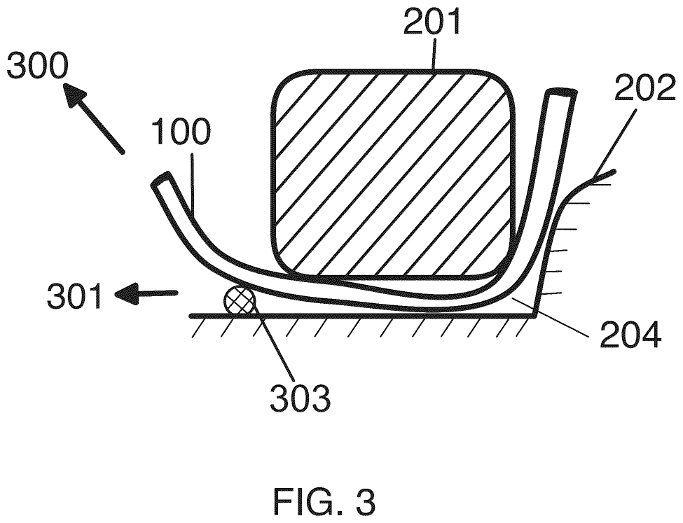

FIG. 3 illustrates cleaning tool 100 used to clean out the debris 400 from the narrow gap 203, which is also illustrated in FIG. 2. Cleaning tool 100 may be inserted into the narrow gap 203 and pulled in direction 300. In some embodiments, the cleaning tool 100 may be pulled by the user gripping a handle of the tool. The semi-rigid material forming the cleaning tool 100 may flexibly bend around the bent portion 204, while maintaining its shape. Thus, the cleaning tool 100 may move through the narrow gap along its length L direction (as shown in FIG. 1) and push the debris 303 in direction 301. This may remove the debris 303 from the narrow gap 203.

Alternatively, the cleaning tool 100 may be pushed by the user to remove debris from the narrow gap 203. In some embodiments, the user may push or pull the cleaning tool 101 using a handle or grip on the body of the cleaning tool 101.

In addition to removing debris that may be discarded, the cleaning tool 101 may also help the user retrieve objects that have fallen into hard-to-reach spaces. The cleaning tool 100's size and material may be particularly useful within a car, such as for the spaces below a car seat. The material may be able to produce a static electric charge to help capture debris.

The cleaning tool 100 may be produced in a small size that is convenient for the user to carry in a pocket or purse to keep in an automobile. Thus, the cleaning tool available when needed. The single-body design may simplify manufacturing and reduce production costs.

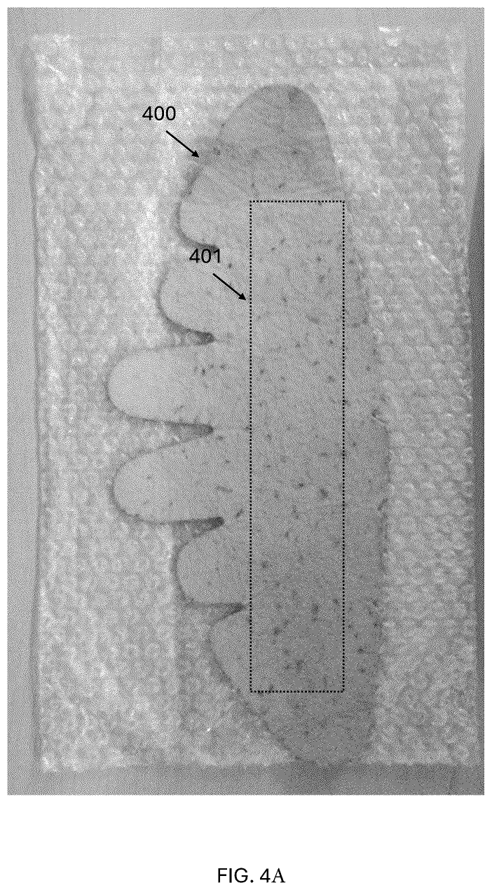

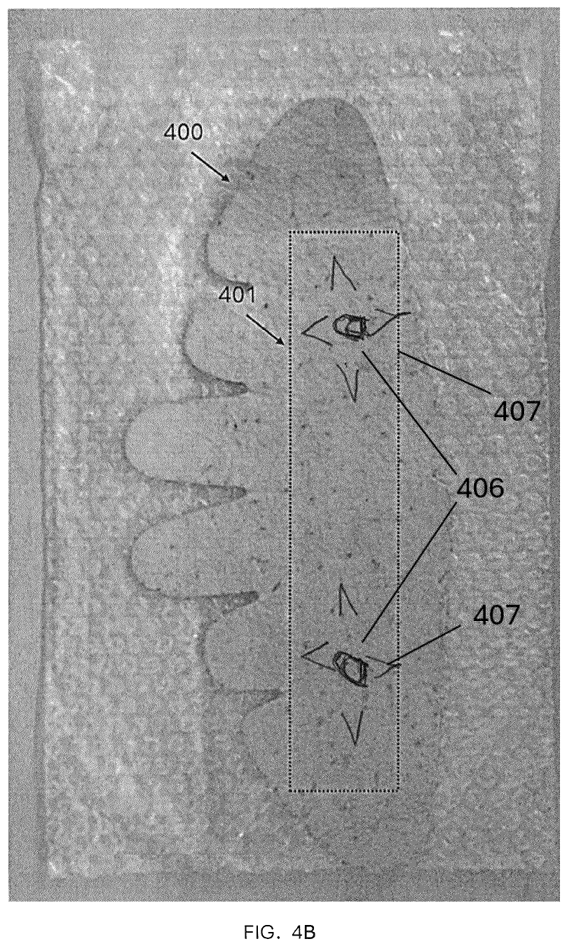

FIG. 4A is an illustration of a cleaning tool 400. The cleaning tool 400 includes a rectangular portion 401, where the rectangular portion 401 comprises a stiffened felt material. The remainder of the cleaning tool 400 comprises a similar felt material. One or more protrusions extend from the cleaning tool 400. These protrusions may help to gather debris, due to their irregular size and shape.

FIG. 4B is an illustration of a cleaning tool 400 with thumbprints 406 and corresponding sets of cutouts 407. The thumbprints 406 and corresponding sets of cutouts 407 may be indicated by a change in material or color, and may comprise a handle.

Embodiments have been disclosed herein, and although terms are employed, they are used and are to be interpreted in a generic and descriptive sense only and not for purpose of limitation. In some instances, as would be apparent by one of ordinary skill in the art, features, characteristics, and/or elements described in connection with an embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the disclosure as set forth in the following claims.

What is claimed:

1. A cleaning tool comprising:
a body having a substantially rectangular portion, the rectangular portion defining a length, a width, and a thickness, wherein the body comprises a felt material, and the length of the rectangular portion is longer than the width of the rectangular portion, and the width of the rectangular portion is longer than the thickness of the rectangular portion.

2. The cleaning tool of claim 1, further comprising at least one tapered portion extending from the body, thereby increasing the length of the rectangular portion.

3. The cleaning tool of claim 2, wherein the at least one tapered portion comprises a handle.

4. The cleaning tool of claim 2, wherein the at least one tapered portion comprises a grip material with a different texture from surface material of the body.

5. The cleaning tool of claim 1, further comprising at least one protrusion extending from the body, thereby increasing the width of the rectangular portion.

6. The cleaning tool of claim 5, wherein the at least one protrusion comprises a handle.

7. The cleaning tool of claim 5, wherein the at least one protrusion comprises a grip material with a different texture from the surface material of the body.

8. The cleaning tool of claim 1, further comprising:
a first protrusion; and
a second protrusion, wherein the second protrusion is larger than the first protrusion, wherein the first and the second protrusion extend from the body, thereby increasing the width of the rectangular portion.

9. The cleaning tool of claim 1, the rectangular portion comprising:
a core portion formed of a semi-rigid material; and
a skin portion encasing the core portion.

10. The cleaning tool of claim 9, wherein a surface of the skin portion comprises a material smoother than that of the core portion.

11. The cleaning tool of claim 9, wherein a surface of the skin portion comprises a material that produces a static electric charge that captures debris.

12. The cleaning tool of claim 1, wherein the felt material of the body comprises a washable material.

13. The cleaning tool of claim 1, wherein the felt material of the body comprises a stiff felt material.

14. The cleaning tool of claim 1, wherein the rectangular portion comprises a rubber or plastic material.

15. The cleaning tool of claim 1, wherein the rectangular portion comprises a stiffened felt material.

16. A method of using a cleaning tool in a small space, the method comprising:
inserting a cleaning tool into a small space, the cleaning tool comprising a body having a substantially rectangular portion, the rectangular portion defining a length, a width, and a thickness;
pulling or pushing the cleaning tool through the small space; and
removing the cleaning tool from the small space; and
optionally removing collected debris from the cleaning tool.

17. The method of claim 16, wherein the cleaning tool further comprises a handle by which a user can pull the cleaning tool.

18. The method of claim 16, wherein the rectangular portion of the cleaning tool defines a length, a width, and a thickness, the length of the rectangular portion is longer than the width of the rectangular portion, and the width of the rectangular portion is longer than the thickness of the rectangular portion.

19. The method of claim 16, wherein the cleaning tool comprises a felt material.

20. The method of claim 16, wherein the small space comprises a gap between a car seat and a floor material of a car.
